(19) United States
(12) Patent Application Publication
(10) Pub. No.: US 2008/0148890 A1
(43) Pub. Date: Jun. 26, 2008

(54) ELECTRIC ACTUATOR, IN PARTICULAR FOR DRIVING A GEARBOX SELECTOR SHAFT

(75) Inventors: Rayford A. Cockerham, Montgomery, TX (US); Jean-Pierre Baz, Passy (FR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Teleflex Automotive France SAS

(21) Appl. No.: 11/949,275

(22) Filed: Dec. 3, 2007

(30) Foreign Application Priority Data
Dec. 21, 2006 (FR) 06/11221

(51) Int. Cl. F16H 27/02

(52) U.S. Cl. 74/143

(57) ABSTRACT

An electric actuator, in particular for driving a gearbox selector shaft, the actuator comprising a coil guided in rotation between two flat permanent magnets carried by yoke plates, the coil being centered on the rotary spindle and having an angular stroke lying in the range 90° to 180°, its rotary spindle being connected by stepdown gearing to the gearbox selector shaft.

### CROSS REFERENCE TO RELATED APPLICATIONS

This application claims priority from French patent application 06/11221 filed Dec. 21, 2006.

The invention relates to an electric actuator, in particular for driving a gearbox selector shaft.

### BACKGROUND OF THE INVENTION

The Applicants' application FR 05/07540 discloses an electric actuator for driving a motor vehicle gearbox selector shaft, which actuator includes a coil guided in rotation between two flat permanent magnets carried by a yoke.

The yoke is made up of top and bottom parallel plates, each carrying a flat permanent magnet, of a middle plate that extends between the top and bottom plates, and of uprights that interconnect the three plates, which plates are in the form of circular sectors.

The coil is made of turns of electrically conductive wire that are wound on an insulating support surrounding the middle plate of the yoke and capable of pivoting about a spindle parallel to the plates of the yoke and passing through the centers of the circular sectors formed by said plates.

That actuator presents numerous advantages compared with devices of the prior art in terms of reducing the weight and the cost of the permanent magnet, and in terms of reducing the weight and the inertia of the coil and the response time of the actuator, but it suffers from the drawback of being sensitive to shock and vibration because the coil is off-center relative to its rotary spindle. In addition, the angular stroke of the coil is relatively small, typically of the order of 40° to 50°.

### OBJECTS AND SUMMARY OF THE INVENTION

A particular object of the present invention is to avoid those drawbacks in an electric actuator for a gearbox selector shaft.

To this end, the invention provides an electric actuator, in particular for driving a gearbox selector shaft, the actuator comprising a coil mounted to turn on a spindle between flat permanent magnets carried by a yoke, connection means connecting the spindle of the coil to the gearbox selector shaft, and means for feeding electricity to the coil, the yoke comprising top and bottom flat plates each carrying a flat permanent magnet with the coil being placed between them, wherein the coil is centered on the rotary spindle and has an angular stroke lying in the range 90° to 180°, and wherein its rotary spindle is connected by stepdown gearing to the gearbox selector shaft.

The electric actuator of the invention presents numerous advantages:
the angular stroke of the coil is at least twice as great as in the prior art, thereby making more energy available for driving the gearbox selector shaft;
the spindle of the coil is connected to said shaft by stepdown gearing, thus making it possible to apply higher rotary torque to the shaft, while conserving a certain amount of reversibility;
the coil is centered on the rotary spindle of the actuator, thus making it relatively insensitive to impacts, bumping, and vibration;
the lack of a yoke plate between the magnets reduces weight and makes it possible to reduce the airgap and thus to reduce the weight of the permanent magnets used;
the inertia of the coil is reduced; and
Joule effect heating is smaller.

According to another characteristic of the invention, the plates of the yoke and the permanent magnets are circular disks centered on the rotary spindle of the coil with said spindle passing through them with clearance.

The coil comprises turns of electrically conductive wire forming parallel conductors wound on a support that is secured to the rotary spindle of the coil and in the form of a disk or a rectangular section bar.

In a first embodiment, the support is electrically insulating.

In a variant embodiment, the support is constituted by a plate of steel or of some other material having ferromagnetic properties.

The coil and the yoke are housed in a housing that carries the yoke and that includes bearings for supporting and guiding rotation of the coil spindle.

The stepdown gearing that connects the spindle of the coil to the gearbox selector shaft comprises a set of meshing toothed wheels, some carried by one end of the coil spindle and the others carried by the housing.

The outlet toothed wheel of the stepdown gearing is connected to the gearbox selector shaft, e.g. by a rigid rod or rodding, and also to a manual control for returning to neutral.

In the event of a breakdown, this enables the gearbox to be returned to neutral using a manual control, and thus making it easier to move the vehicle to a repair shop.

Advantageously, the end of the rotary spindle of the coil is tubular and forms a duct for passing wires for electrically powering the coil.

### BRIEF DESCRIPTION OF THE DRAWINGS

The invention can be better understood and other characteristics, details, and advantages thereof appear more clearly on reading the following description made by way of example with reference to the accompanying drawings, in which:

FIG. 1 is a diagrammatic axial section view of an actuator of the invention;

FIG. 2 is a diagrammatic cross-section view on line II-II of FIG. 1;

FIG. 3 is a diagrammatic perspective view of the coil of the actuator;

FIG. 4 is a diagrammatic plan view of the actuator; and

FIG. 5 is a diagrammatic perspective view of a variant embodiment of the coil of the actuator.

### MORE DETAILED DESCRIPTION

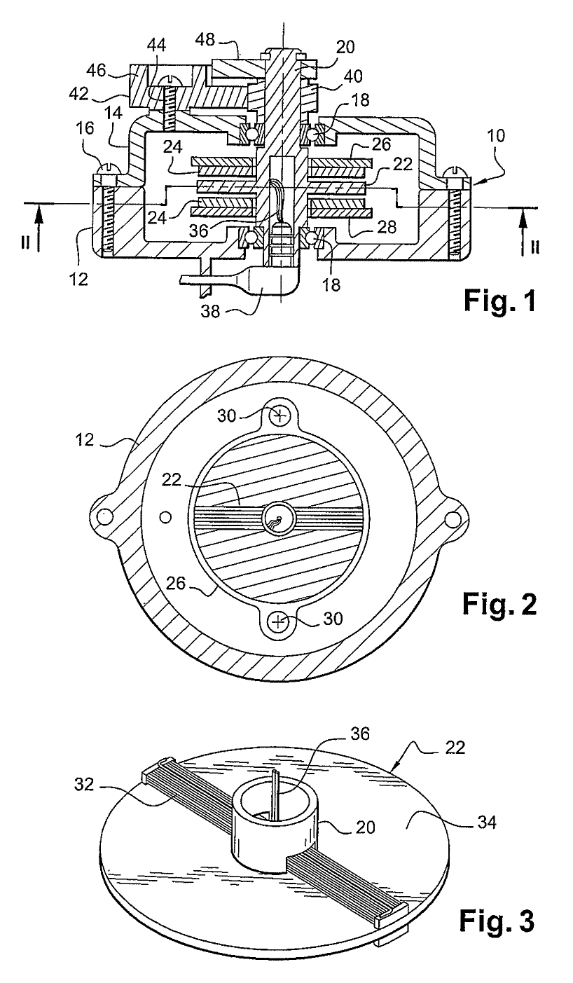

The electric actuator shown diagrammatically in FIG. 1 essentially comprises a housing 10 made up of a base 12 having a cover 14 placed thereon and fastened by means of screws 16, the base 12 and the cover 14 each having a respective central orifice for mounting a bearing such as a ball bearing 18 for centering and guiding pivoting of a spindle 20 that constitutes both the support for a coil 22 and the output member from the actuator.

The coil 22 carried by the spindle 20 is guided in rotation between two flat permanent magnets 24, one of which is fastened on the inside face of a top plate 26 of a magnetic yoke and the other of which is fastened on the top face of a bottom plate 28 of the yoke.

These two plates 26 and 28 and the flat permanent magnets 24 are in the form of circular disks each having a central orifice for passing the spindle 20, and they are fastened to the base 12 and to the cover 14 of the housing by vertical uprights 30 at two diametrically opposite points on their outer peripheries.

The coil 22 is formed by some number of turns 32 of electrically conductive wire that are wound on an insulating support 34 of disk shape so as to form a series of parallel rectilinear conductors that extend diametrally relative to the disk 34 over both of its faces, thus forming a kind of rectilinear conductor bar on each face of the disk 34.

The disk 34 is carried by the spindle 20 whose bottom end may be tubular so as to constitute a duct for passing wires 36 for electrically powering the coil. These wires may be connected to a connector 38 that is mounted in the bottom end of the spindle 20, e.g. by clip fastening.

The top end of the spindle extends above the housing 10 and is constrained to rotate with a first toothed wheel 40 that meshes with a second toothed wheel 42 rotatably mounted about a pin 44 on the cover and including a top sleeve 46 with outside teeth meshing with a third toothed wheel 48 rotatably mounted on the top end of the spindle 20.

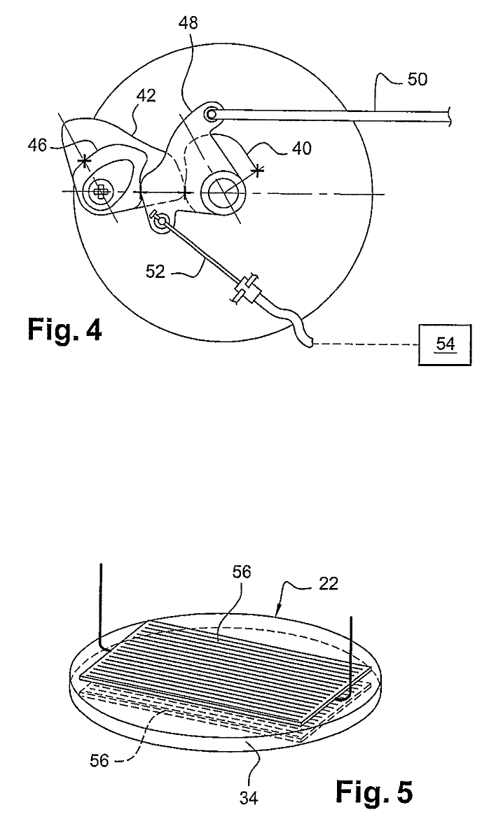

This third toothed wheel 48 forms the outlet element of stepdown gearing whose inlet element is the spindle 20, and it is connected to the selector shaft of a gearbox, e.g. by means of a rod 50 as shown in FIG. 4.

As can be seen in FIG. 4, the toothed wheels 40, 42, and 48 and the sleeve 46 have outlines that are not circular in shape, thus making it possible to have a relationship between stroke and force that is non-linear so as to adapt to the characteristic between torque and angle of rotation of the actuator to match the requirements of automobile manufacturers.

The third toothed wheel 48 which is the outlet element of stepdown gearing, may be connected by a cable 52 to manual control means 54 installed on board the vehicle so that in the event of a breakdown, the gearbox selector shaft can be put into neutral by pulling on the cable 52.

The angular travel of the coil 22 about the axis of the spindle 20, in this embodiment, is about 170°. The transmission ratio of stepdown gearing is about 2 to 6, thus making it possible to increase the torque applied to the gearbox selector shaft while conserving the advantages of a certain amount of reversibility.

In the variant embodiment of FIG. 5, the coil 22 is made up of two series 56 of parallel conductors placed on the two faces of an insulating disk 34, the two series 56 of conductor wires forming kinds of conductor plates that are rectangular in shape.

In the embodiments described and shown, the magnetic circuit is formed by the plates 26 and 28 of the yoke, and the electricity fed to the coil 22 flows in the same direction in the conductor wires that are located above and below the insulating support 34.

In a variant embodiment in which the support 34 of the coil is a plate of ferromagnetic material, e.g. steel, then the electric current fed to the coil 22 flows in opposite directions in the conductor wires situated above and below the plate.

In these various embodiments, when the torque that needs to be applied to the coil is relatively low, it is possible to omit one of the magnets situated above or below the coil.

What is claimed is:

1. An electric actuator, in particular for driving a gearbox selector shaft, the actuator comprising a coil mounted to turn on a spindle between flat permanent magnets carried by a yoke, connection means connecting the spindle of the coil to the gearbox selector shaft, and means for feeding electricity to the coil, the yoke comprising top and bottom flat plates each carrying a flat permanent magnet with the coil being placed between them, wherein the coil is centered on the rotary spindle and has an angular stroke lying in the range 90° to 180°, and wherein its rotary spindle is connected by stepdown gearing to the gearbox selector shaft.

2. An actuator according to claim 1, wherein the plates of the yoke and the permanent magnets are circular disks centered on the rotary spindle of the coil with said spindle passing through them with clearance.

3. An actuator according to claim 1, wherein the coil comprises turns of electrically conductive wire forming parallel conductors wound on a support that is secured to the rotary spindle of the coil.

4. An actuator according to claim 3, wherein the support is in the form of a disk or of a rectangular section bar.

5. An actuator according to claim 3, wherein the support is electrically insulating.

6. An actuator according to claim 3, wherein the support is made of ferromagnetic material.

7. An actuator according to claim 1, wherein the coil and the yoke are housed in a housing that carries the yoke and that includes bearings for supporting and guiding rotation of the coil spindle.

8. An actuator according to claim 7, wherein the stepdown gearing comprises a set of meshing toothed wheels, some carried by one end of the coil spindle and the others carried by the housing.

9. An actuator according to claim 8, wherein the outlet toothed wheel from the stepdown gearing is connected to the gearbox selector shaft and to a manual control for returning to neutral.

10. An actuator according to claim 1, wherein the end of the rotary spindle of the coil is tubular and forms a duct for passing wires for electrically powering the coil.
